(19) United States
(12) Patent Application Publication
(10) Pub. No.: US 2023/0259109 A1
(43) Pub. Date: Aug. 17, 2023

(54) METHOD AND SYSTEM FOR DETERMINING ABNORMALITY IN INDUSTRIAL MACHINE

(71) Applicant: KOMATSU INDUSTRIES CORPORATION, Kanazawa-shi, Ishikawa (JP)

(72) Inventors: Eiji DOBA, Ishikawa (JP); Yuusuke MASATOU, Ishikawa (JP); Eri NOZAKI, Ishikawa (JP)

(21) Appl. No.: 18/006,890

(22) PCT Filed: Sep. 3, 2021
(86) PCT No.: PCT/JP2021/032386

§ 371 Date: Jan. 26, 2023

(30) Foreign Application Priority Data
Oct. 26, 2020 (JP) 2020-178901

(51) Int. Cl. G05B 23/02

(52) U.S. Cl. CPC G05B 23/0218

(57) ABSTRACT

A first process acquires drive system data indicating a dynamic state of a drive system. A second process performs frequency analysis on the drive system data so as to acquire analysis data indicating a power spectrum of the drive system data. A third process derives the Gaussian distribution of the analysis data and acquires a feature amount indicating the Gaussian distribution. A fourth process determines whether the drive system is operating abnormally based on the feature amount.

### CROSS-REFERENCE TO RELATED APPLICATIONS

This application is a U.S. National stage application of International Application No. PCT/JP2021/032386, filed on Sep. 3, 2021. This U.S. National stage application claims priority under 35 U.S.C. § 119(a) to Japanese Patent Application No. 2020-178901, filed in Japan on Oct. 26, 2020, the entire contents of which are hereby incorporated herein by reference.

The present disclosure relates to a method and a system for determining an abnormality in an industrial machine

### BACKGROUND INFORMATION

Detecting the occurrence of abnormalities may be desired in an industrial machine. As a result, in the prior art, an abnormality is assessed by detecting a predetermined output value of the industrial machine with a sensor and comparing the detected output value with a threshold (for example, see Japanese Patent Laid-open No. H02-195498).

### SUMMARY

In order to prevent stoppage due to a failure or to reduce maintenance costs in an industrial machine, there is a need to detect that an abnormal state is approaching and perform maintenance before the machine fails. However, in the afore-mentioned prior art, it is not easy to accurately detect that an industrial machine is approaching an abnormal state. An object of the present disclosure is to easily and accurately determine an abnormality in an industrial machine.

A method according to an aspect of the present disclosure is a method executed by one or more computers for determining an abnormality in an industrial machine that includes a drive system. The method according to the present aspect includes the following processes. A first process is acquiring drive system data indicating a dynamic state of the drive system. A second process is performing frequency analysis on the drive system data so as to acquire analysis data indicating a power spectrum of the drive system data. A third process is deriving a Gaussian distribution of the analysis data and acquiring a feature amount indicating the Gaussian distribution. A fourth process is determining whether the drive system is operating abnormally based on the feature amount. The order of the execution of the processes is not limited to the above-mentioned order and may be changed.

A system according to another aspect of the present disclosure is a system for determining an abnormality in an industrial machine that includes a drive system, the system comprising a local computer and a server. The local computer acquires drive system data indicating a dynamic state of the drive system. The local computer performs frequency analysis on the drive system data to acquire analysis data indicating a power spectrum of the drive system data. The local computer derives a Gaussian distribution of the analysis data and acquires a feature amount indicating the Gaussian distribution. The server is configured to communicate with the local computer. The server acquires the feature amount from the local computer. The server determines whether the drive system is operating abnormally based on the feature amount.

Based on the method and system according to the present disclosure, an abnormality in an industrial machine can be determined easily and accurately.

### BRIEF DESCRIPTION OF DRAWINGS

FIG. 1 is a schematic view of a predictive maintenance system according to an embodiment.

FIG. 2 is a front view of an industrial machine.

FIG. 3 illustrates a slide drive system.

FIG. 4 illustrates a die cushion drive system.

FIG. 5 is a flow chart illustrating processing executed by a local computer.

FIG. 6A illustrates an example of analysis data.

FIG. 6B illustrates an example of a Gaussian distribution of the analysis data.

FIG. 7 is a flow chart illustrating processing executed by a server.

FIG. 8 is a flow chart illustrating processing executed by the local computer.

FIG. 9 is a flow chart illustrating processing executed by the server.

FIG. 10A illustrates a determination model.

FIG. 10B illustrates a determination model.

FIG. 11A illustrates an example of analysis data during abnormal operation.

FIG. 11B illustrates an example of analysis data during normal operation.

FIG. 12 illustrates an example of a maintenance management screen.

FIG. 13 illustrates an example of a maintenance management screen.

FIG. 14 illustrates an example of a maintenance component management screen.

### DESCRIPTION OF EMBODIMENTS

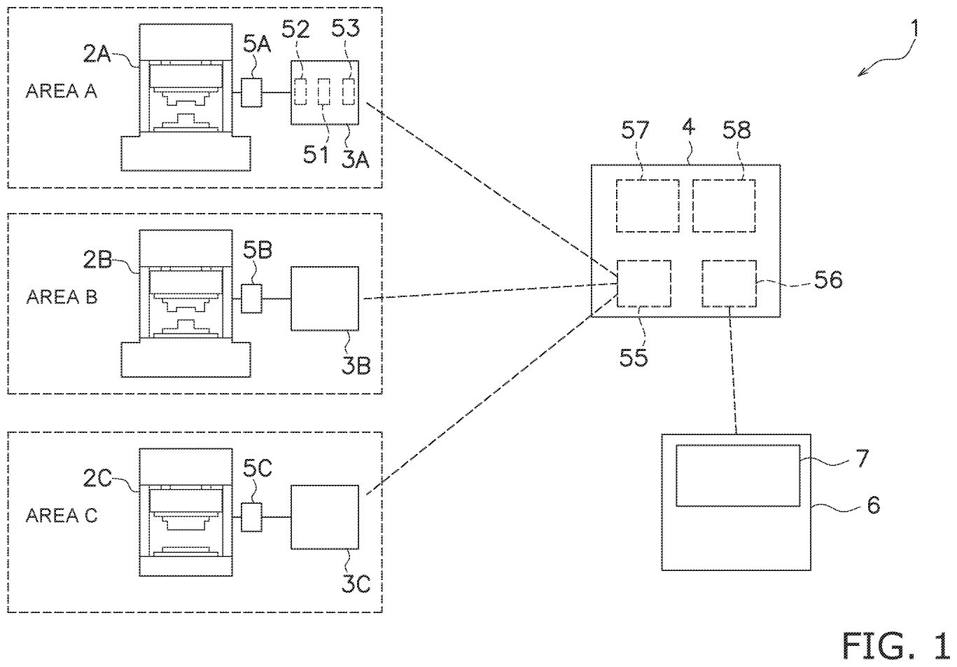

The following is an explanation of an embodiment with reference to the accompanying drawings. FIG. 1 is a schematic view of a predictive maintenance system 1 according to an embodiment. The predictive maintenance system 1 is a system for determining a component to be subjected to maintenance before the occurrence of a failure in an industrial machine. The predictive maintenance system 1 includes industrial machines 2A-2C, local computers 3A-3C, and a server 4.

As illustrated in FIG. 1, the industrial machines 2A-2C may be disposed in different areas. Alternatively, the industrial machines 2A-2C may be disposed in the same area. For example, the industrial machines 2A-2C may be disposed in different factories. Alternatively, the industrial machines 2A-2C may be disposed in the same factory. The industrial machines 2A-2C in the present embodiment are presses. Three industrial machines are depicted in FIG. 1. However, the number of the industrial machines may be less than three or more than three.

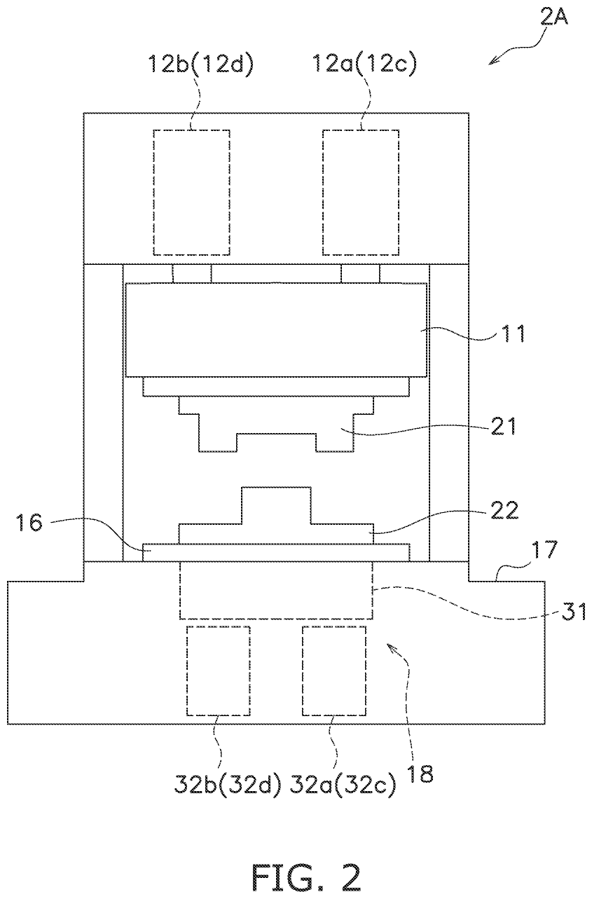

FIG. 2 is a front view of an industrial machine 2A. The industrial machine 2A includes a slider 11, a plurality of slide drive systems 12a-12d, a bolster 16, a bed 17, a die cushion device 18, and a controller 5A (see FIG. 1). The slider 11 is provided so as to be able to move up and down. An upper die 21 is attached to the slider 11. The plurality of slide drive systems 12a-12d move the slider 11. The industrial machine 2A includes, for example, four slide drive systems 12a-12d. In FIG. 2, two of the slide drive systems 12a and 12b are depicted. The other slide drive systems 12c and 12d are disposed behind the slide drive systems 12a and 12b. However, the number of the slide drive systems may be less than four or more than four.

The bolster 16 is disposed below the slider 11. A lower die 22 is attached to the bolster 16. The bed 17 is disposed below the bolster 16. The die cushion device 18 applies an upward load to the lower die 22 during pressing. Specifically, the die cushion device 18 applies an upward load to a blank holder part of the lower die 22 during pressing. The controller 5A controls the operations of the slider 11 and the die cushion device 18.

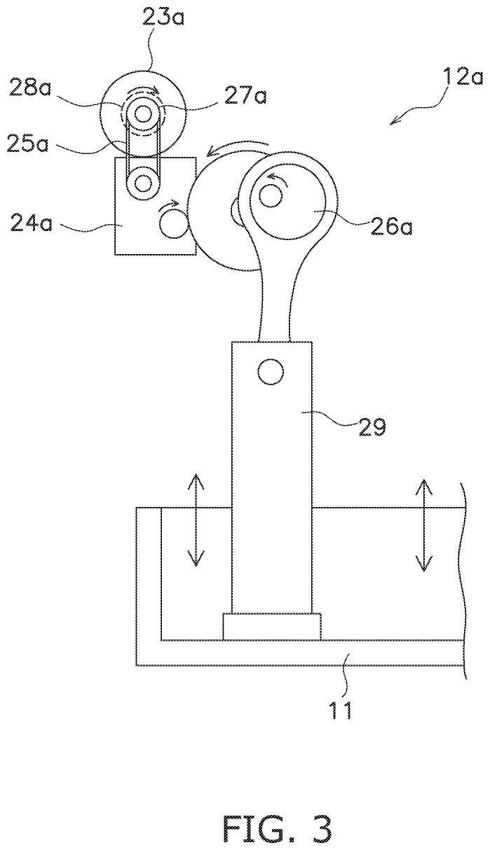

FIG. 3 illustrates the slide drive system 12a. As illustrated in FIG. 3, the slide drive system 21a includes a plurality of components, such as a servomotor 23a, a speed reduction gear 24a, a timing belt 25a, and a connecting rod 26a. The servomotor 23a, the speed reduction gear 24a, the timing belt 25a, and the connecting rod 26a are coupled to each other so as to operate in conjunction.

The servomotor 23a is controlled by the controller 5A. The servomotor 23a includes an output shaft 27a and a motor bearing 28a. The motor bearing 28a supports the output shaft 27a. The speed reduction gear 24a includes a plurality of gears. The speed reduction gear 24a is coupled to the output shaft 27a of the servomotor 23a via the timing belt 25a. The speed reduction gear 24a is coupled to the connecting rod 26a. The connecting rod 26a is connected to a support shaft 29 of the slider 11. The support shaft 29 is able to slide in the up-down direction with respect to a support shaft holder (not illustrated). The driving power of the servomotor 23a is transferred to the slider 11 via the timing belt 25a, the speed reduction gear 24a, and the connecting rod 26a. As a result, the slider 11 moves up and down.

The other slide drive systems 12b-12d also have configurations similar to the above-mentioned slide drive system 12a. In the following explanations, the items corresponding to the configuration of the slide drive system 12a among the other slide drive systems 12b-12d are given reference symbols made up of the same numbers as in the configuration of the slide drive system 12a and of the same letters as those of the respective slide drive system 12b-12d. For example, the slide drive system 12b includes a servomotor 23b. The slide drive system 12c includes a servomotor 23c.

As illustrated in FIG. 2, the die cushion device 18 includes a cushion pad 31 and a plurality of die cushion drive systems 32a-32d. The cushion pad 31 is disposed below the bolster 16. The cushion pad 31 is provided so as to be able to move up and down. The plurality of die cushion drive systems 32a-32d move the cushion pad 31 up and down. The industrial machine 2A includes, for example, four die cushion drive systems 32a-32d. However, the number of the die cushion drive systems is not limited to four and may be less than four or more than four. In FIG. 2, two of the die cushion drive systems 32a and 32b are depicted. The other die cushion drive systems 32c and 32d are disposed behind the die cushion drive systems 32a and 32b.

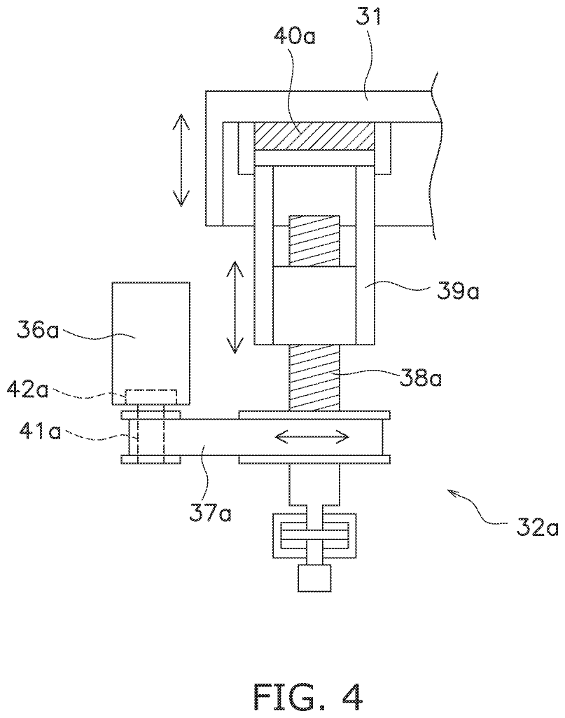

FIG. 4 illustrates the die cushion drive system 32a. As illustrated in FIG. 4, the die cushion drive system 32a includes a plurality of components, such as a servomotor 36a, a timing belt 37a, a ball screw 38a, and a drive member 39a. The servomotor 36a, the timing belt 37a, and the ball screw 38a are coupled to each other so as to operate in conjunction. The servomotor 36a is controlled by the controller 5A. The servomotor 36a includes an output shaft 41a and a motor bearing 42a. The motor bearing 42a supports the output shaft 41a.

The output shaft 41a of the servomotor 36a is coupled to the ball screw 38a via the timing belt 37a. The ball screw 38a moves up and down by rotation. The drive member 39a includes a nut part that is screwed to the ball screw 38a. The drive member 39a moves up and down due to being pressed by the ball screw 38a. The drive member 39a includes a piston disposed in an oil chamber 40a. The drive member 39a supports the cushion pad 31 via the oil chamber 40a.

The other die cushion drive systems 32b-32d also have the same configuration as the above-mentioned die cushion drive system 32a. In the following explanations, the items corresponding to the configuration of the die cushion drive system 32a among the other die cushion drive systems 32b-32d are given reference symbols made up of the same numbers as in the configuration of the die cushion drive system 32a and of the same letters as those of the respective die cushion drive systems 32b-32d. For example, the die cushion drive system 32b includes a servomotor 36b. The die cushion drive system 32c includes a servomotor 36c.

The configurations of the other industrial machines 2B and 2C are the same as the above-mentioned industrial machine 2A. As illustrated in FIG. 1, the industrial machines 2B and 2C are respectively controlled by controllers 5B and 5C. The industrial machines 2A-2C may not be provided with the die cushion device. For example, the industrial machine 2C may be a press not provided with a die cushion device.

The local computers 3A-3C communicate with the controllers 5A-5C of the respective industrial machines 2A-2C. As illustrated in FIG. 1, the local computer 3A includes a processor 51, a storage device 52, and a communication device 53. The processor 51 is, for example, a central processing unit (CPU). Alternatively, the processor 51 may be a processor different from a CPU. The processor 51 executes a process for predictive maintenance of the industrial machine 2A according to a program.

The storage device 52 includes a non-volatile memory, such as a ROM, and a volatile memory, such as a RAM. The storage device 52 may also include an auxiliary storage device, such as a hard disk or a solid state drive (SSD). The storage device 52 is an example of a non-transitory computer-readable recording medium. The storage device 52 stores computer commands and data for controlling the local computer 3A. The communication device 53 communicates with the server 4. The configurations of the other local computers 3B and 3C are the same as that of the local computer 3A.

The server 4 collects data for predictive maintenance from the industrial machines 2A-2C via the local computers 3A-3C. The server 4 executes a predictive maintenance service based on the collected data. Components to be subjected to predictive maintenance are identified in the predictive maintenance service. The server 4 communicates with a client computer 6. The server 4 provides the predictive maintenance service to the client computer 6.

The server 4 includes a first communication device 55, a second communication device 56, a processor 57, and a storage device 58. The first communication device 55 communicates with the local computers 3A-3C. The second communication device 56 communicates with the client computer 6. The processor 57 is, for example, a central processing unit (CPU). Alternatively, the processor 57 may be a processor different from a CPU. The processor 57 executes a process for the predictive maintenance service according to a program.

The storage device 58 includes a non-volatile memory, such as a ROM, and a volatile memory, such as a RAM. The storage device 58 may also include an auxiliary storage device, such as a hard disk or a solid state drive (SSD). The storage device 58 is an example of a non-transitory computer-readable recording medium. The storage device 58 stores computer commands and data for controlling the server 4.

The above-mentioned communication may be performed over a mobile communication network such as 3G, 4G, or 5G. Alternatively, the communication may be performed over another wireless communication network such as by satellite communication. Alternatively, the communication may be performed via a computer communication network, such as a LAN, a VPN, or the Internet. Alternatively, the communication may be performed over a combination of any of the above communication networks.

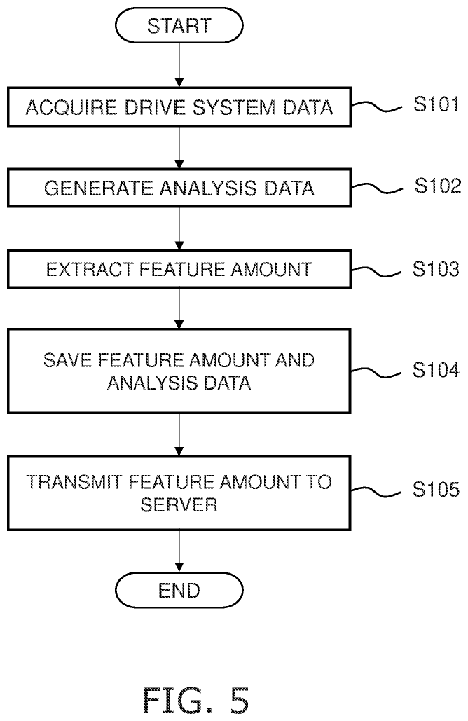

Processing for the predictive maintenance service is explained next. FIG. 5 is a flow chart illustrating processing executed by the local computers 3A-3C. While the following discusses a situation of the local computer 3A executing the processing illustrated in FIG. 5A, the other local computers 3B and 3C execute the same processing as the local computer 3A.

In step S101, the local computer 3A acquires drive system data from the controller 5A of the industrial machine 2A as illustrated in FIG. 5. The drive system data indicates a dynamic state of the drive system of the industrial machine 2A. The drive system data includes the accelerations of the components included in the drive systems 12a-12d and 32a-32d. For example, the drive system data includes the angular accelerations of the servomotors 23a-23d and 36a-36d. The angular accelerations may be calculated from the rotation speeds of the servomotors 23a-23d and 36a-36d. Alternatively, the angular accelerations may be detected with a sensor such as a vibration sensor. The following discusses the situation when the local computer 3A acquires the drive system data of the drive system 12a.

The local computer 3A acquires the drive system data of the drive system 12a when a predetermined starting condition is satisfied. The predetermined starting condition may include the fact that a predetermined time period has passed since the previous acquisition. The predetermined time period is, for example, several hours but is not limited thereto. The predetermined starting condition may include the fact that the rotation speed of the servomotor 23a has exceeded a predetermined threshold. The predetermined threshold is preferably a value that indicates, for example, a state in which the industrial machine 2A is in operation and is not performing pressing.

The local computer 3A acquires a plurality of values of the angular acceleration of the servomotor 23a at a predetermined sampling intervals. The sample number is, for example, several hundred to several thousand but is not limited thereto. One unit of the drive system data includes a plurality of angular accelerations sampled during a predetermined time period. The predetermined time period may be, for example, a time period corresponding to several rotations of the servomotor 23a.

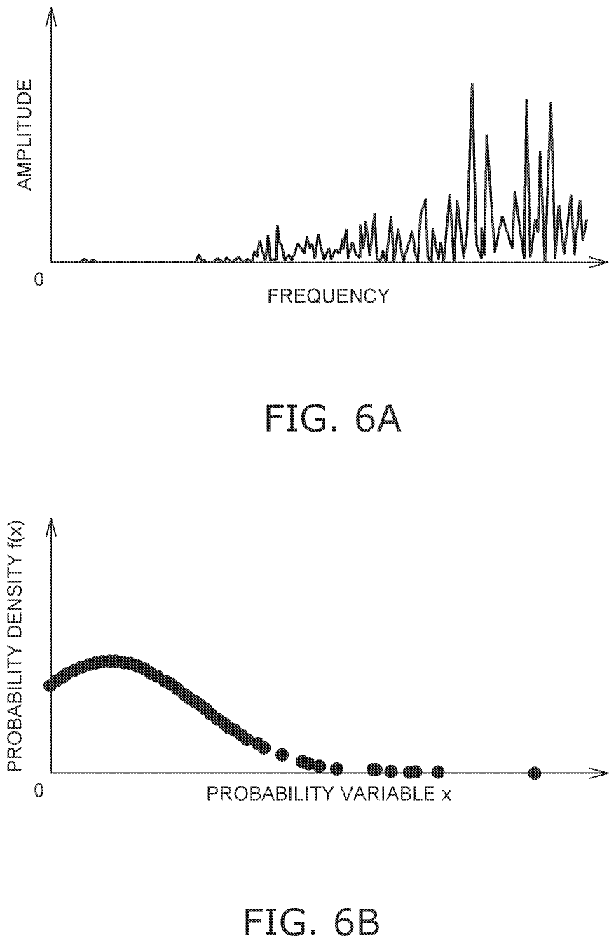

In step S102, the local computer 3A generates analysis data. The local computer 3A generates the analysis data from the drive system data by means of fast Fourier transform. FIG. 6A illustrates an example of the analysis data. In FIG. 6A, the horizontal axis is the frequency and the vertical axis is the amplitude. The analysis data represents a power spectrum value for each frequency of the fast Fourier transform.

In step S103, the local computer 3A extracts feature amounts from the analysis data. The local computer 3A acquires, as the feature amounts, an average and a standard deviation of the analysis data by performing Gaussian distribution on the analysis data. FIG. 6B illustrates an example of a Gaussian distribution of the analysis data. In FIG. 6B, the horizontal axis is a probability variable x and represents a power spectrum value. The vertical axis represents a probability density f(x). The probability density f(x) is expressed with the following formula (1). In formula (1), “p” is the average. “σ” is the standard deviation.

$$f ( x ) = \frac{1}{\sqrt{2 π} σ} exp ( - \frac{{( x - μ )}^{2}}{2 {σ}^{2}} ) \qquad ( 1 )$$

In step S104, the local computer 3A saves the analysis data and the feature amounts in the storage device 52. The local computer 3A saves data that indicates the acquisition time of the drive system data corresponding to the analysis data and the feature amounts, with the analysis data and the feature amounts. In step S105, the local computer 3A transmits the feature amounts to the server 4. At this time, the local computer 3A transmits the feature amounts and not the analysis data, to the server 4.

The local computer 3A generates one unit of a state data file pertaining to the drive system 12a, and saves the state data file in the storage device 52. The one unit of the state data file includes the one unit of the drive system data, the analysis data transformed from the drive system data, and the feature amount.

In addition, the state data file includes data indicating the time that the drive system data was acquired. The state data file includes data indicating an identifier of the state data file. The state data file includes data indicating an identifier of the corresponding drive system. The identifier may also be a name or a code. The local computer 3A transmits, to the server 4, the feature amounts and the identifier of the state data file corresponding to the feature amounts.

The local computer 3A executes the same processing as described above on the other drive systems 12b-12d and 32a-32d. The local computer 3A generates state data files for each of the other drive systems 12b-12d and 32a-32d. The local computer 3A transmits, to the server 4, the feature amounts and the identifiers of the state data files corresponding to the feature amounts for each of the other drive systems 12b-12d and 32a-32d. In addition, the local computer 3A repeats the above processing at predetermined times. Consequently, a plurality of the state data files for each of the predetermined times are stored in the storage device 52. Consequently, a plurality of the state data files acquired in a time sequence are accumulated in the storage device 52.

The local computer 3B executes the same processing as the local computer 3A on the industrial machine 2B. Additionally, the local computer 3C executes the same processing as the local computer 3A on the industrial machine 2C.

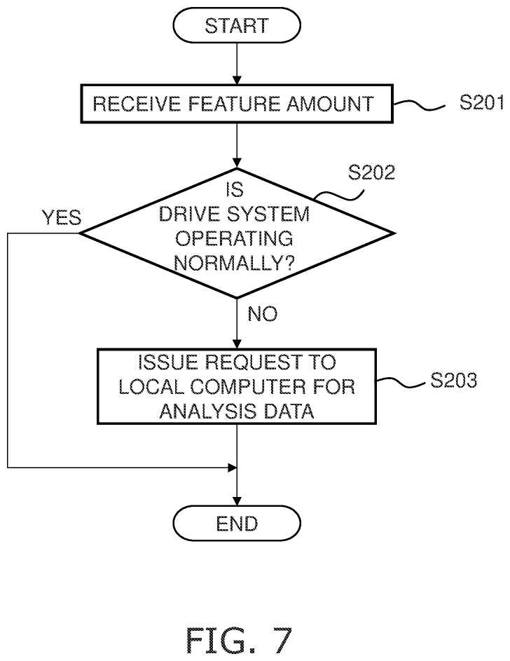

FIG. 7 is a flow chart illustrating processing executed by the server 4. The processing when the server 4 receives the feature amounts from the local computer 3A is discussed below. As illustrated in FIG. 7, in step S201, the server 4 receives the feature amounts. The server 4 receives the feature amounts from the local computer 3A.

In step S202, the server 4 determines whether the drive systems 12a-12d and 32a-32d are operating normally. The server 4 determines whether each of the drive systems 12a-12d and 32a-32d are operating normally from the feature amounts corresponding to the drive systems 12a-12d and 32a-32d. The determination of whether the drive systems 12a-12d and 32a-32d are operating normally may be performed with a determination method well known in quality engineering. For example, the server 4 may use the Mahalanobis-Taguchi method (MT method) to determine whether the drive systems 12a-12d and 32a-32d are operating normally. In this case, the server 4 calculates the Mahalanobis distances of the feature amounts received from the local computer 3A based on the feature amount when the drive systems 12a-12d and 32a-32d are operating normally. The server 4 determines that at least one of the drive systems 12a-12d and 32a-32d is not operating normally when the Mahalanobis distance is greater than a threshold. However, the server 4 may determine whether the drive systems 12a-12d and 32a-32d are operating normally by using another method.

When the server 4 determines that at least one of the drive systems 12a-12d and 32a-32d is not operating normally in step S202, the processing advances to step S203. The drive systems 12a-12d and 32a-32d not operating normally signifies that although the drive systems 12a-12d and 32a-32d have not failed yet, the drive systems 12a-12d and 32a-32d are in a state in which deterioration has progressed to a certain degree.

In step S203, the server 4 issues a request to the local computer 3A for the analysis data. The server 4 transmits a request signal for transmitting the analysis data, to the local computer 3A. The request signal includes the identifier of the state data file corresponding to the drive system that has been determined to be not operating normally. The server 4 transmits the request signal to the local computer 3A and requests the analysis data of the state data file in question.

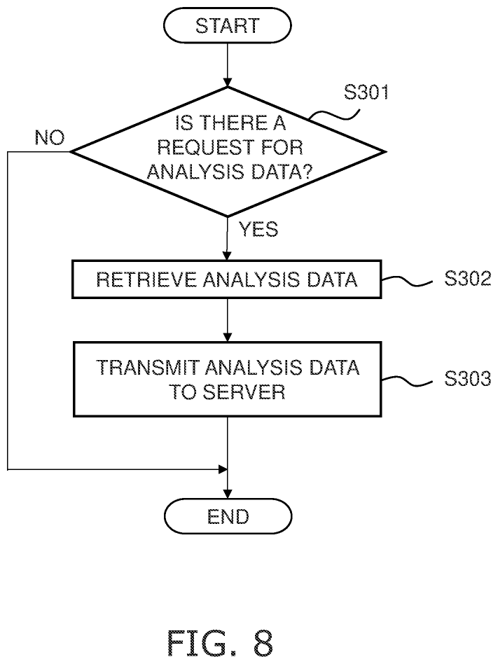

FIG. 8 is a flow chart illustrating processing executed by the local computer 3A. As illustrated in FIG. 8, in step S301, the local computer 3A determines whether there is a request for analysis data from the server 4. The local computer 3A determines that there is a request for analysis data upon receiving the abovementioned request signal from the server 4.

In step S302, the local computer 3A retrieves the analysis data. The local computer 3A retrieves the analysis data of the requested state data file from the plurality of state data files saved in the storage device 52. In step S303, the local computer 3A transmits the requested analysis data to the server 4.

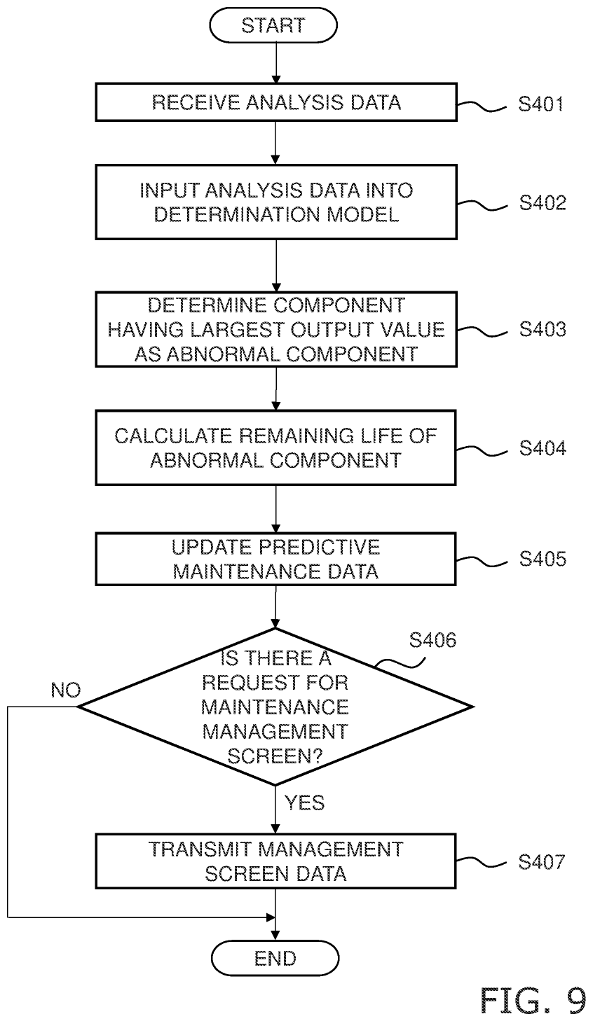

FIG. 9 is a flow chart illustrating processing executed by the server 4. As illustrated in FIG. 9, in step S401, the server 4 receives the analysis data from the local computer 3A. The server 4 saves the analysis data in the storage device 58. In step S402, the server 4 inputs the analysis data into determination models 60 and 70.

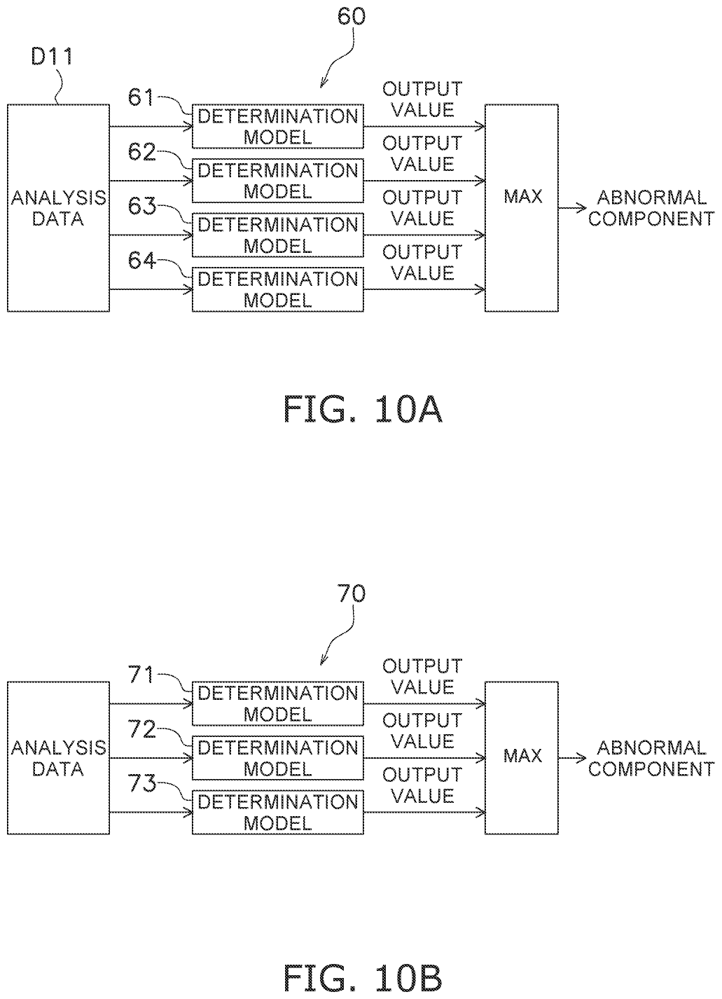

As illustrated in FIG. 10A and FIG. 10B, the server has the determination models 60 and 70. The determination models 60 and 70 are models that have been trained through machine learning so as to output the possibility of an abnormality of a component included in a drive system using the analysis data as the input. The determination models 60 and 70 include artificial intelligence algorithms and parameters tuned through training. The determination models 60 and 70 are saved as data in the storage device 58. The determination models 60 and 70 include, for example, a neural network. The determination models 60 and 70 include a deep neural network, such as a convolutional neural network (CNN).

The server 4 has the determination model 60 for the slide drive systems 12a-12d and the determination model 70 for the die cushion drive systems 32a-32d. The determination model 60 includes a plurality of determination models 61-64. The determination models 61-64 correspond respectively to the plurality of components included the slide drive systems 12a-12d. The determination model 60 outputs values indicating the possibility of an abnormality of the corresponding component based on a waveform of the inputted analysis data. The determination models 61-64 are trained using learning data.

The determination model 70 includes a plurality of determination models 71-73. The determination models 71-73 correspond respectively to the plurality of components included the die cushion drive systems 32a-32d. The determination model 70 outputs values indicating the possibility of an abnormality of the corresponding component based on a waveform of the inputted analysis data. The determination models 71-73 are trained using learning data.

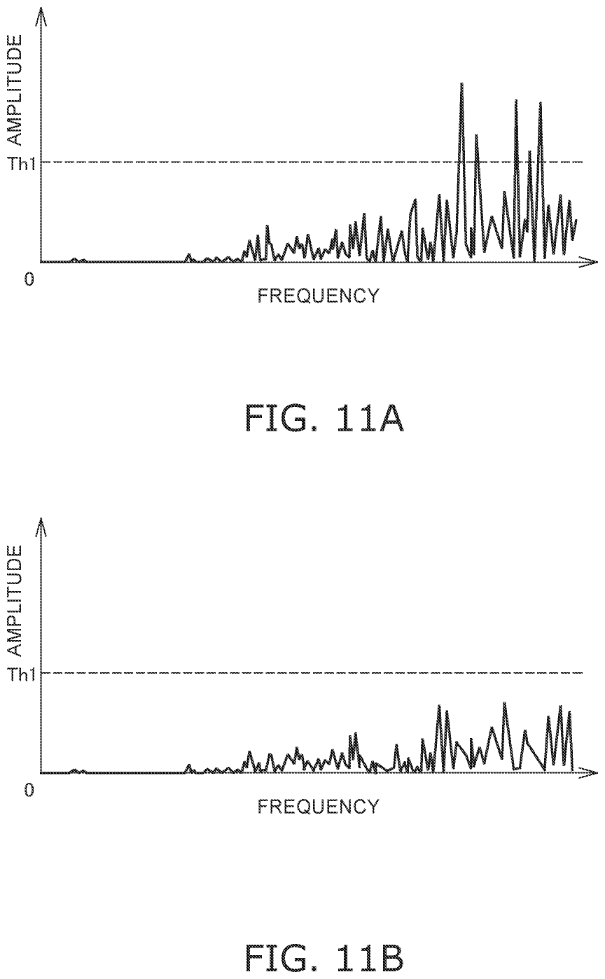

The learning data includes analysis data during abnormal operation and analysis data during normal operation. FIG. 11A is an example of analysis data during abnormal operation. FIG. 11B is an example of analysis data during normal operation. The analysis data during abnormal operation is analysis data from immediately before the occurrence of the abnormality at the corresponding component until before a predetermined period after the occurrence time of the abnormality. As illustrated in FIG. 11A, a plurality of peaks in the waveform exceed a predetermined threshold Th1 in the analysis data during abnormal operation. The analysis data during normal operation is analysis data in which the usage time of the component is shorter and when the abnormality has not occurred. All of the peaks in the waveform are lower than the predetermined threshold Th1 in the analysis data during normal operation.

As illustrated in FIG. 10A in the present embodiment, the server 4 has the determination model 61 for the motor bearing, the determination model 62 for the timing belt, the determination model 63 for the connecting rod, and the determination model 64 for the speed reduction gear of the respective slide drive systems 12a-12d. The determination model 61 for the motor bearing outputs a value indicating the possibility of abnormalities in the motor bearings 28a-28d from the analysis data. The determination model 62 for the timing belt outputs a value indicating the possibility of abnormalities in the timing belts 25a-25d from the analysis data. The determination model 63 for the connecting rod outputs a value indicating the possibility of abnormalities in the connecting rods 26a-26d from the analysis data. The determination model 63 for the speed reduction gear outputs a value indicating the possibility of abnormalities in the speed reduction gears 24a-24d from the analysis data.

As illustrated in FIG. 10B in the present embodiment, the server 4 has the determination model 71 for the motor bearing, the determination model 72 for the timing belt, and the determination model 73 for the ball screw of the die cushion drive systems 32-32d. The determination model 71 for the motor bearing outputs a value indicating the possibility of abnormalities in the motor bearings 42a-42d from the analysis data. The determination model 72 for the timing belt outputs a value indicating the possibility of abnormalities in the timing belts 37a-37d from the analysis data. The determination model 73 for the ball screw outputs a value indicating the possibility of abnormalities in the ball screws 38a-38d from the analysis data.

The server 4 inputs the analysis data acquired in step S401 into the respective determination models 61-64 or the respective determination models 71-73. For example, when the slide drive system 12a is determined as not operating normally, the server 4 inputs the analysis data of the drive system 12a into the determination models 61-64. Consequently, the server 4 acquires, as output values, values indicating the possibility of an abnormality in each of the components of the slide drive system 12a.

Alternatively, when the die cushion drive system 32a is determined as not operating normally, the server 4 inputs the analysis data of the die cushion drive system 32a into the determination models 71-73. Consequently, the server 4 acquires, as output values, values indicating the possibility of an abnormality in each of the components of the die cushion drive system 32a.

In step S403, the server 4 determines the component having the largest output value as the abnormal component. For example, the server 4 determines the component corresponding to the largest value among the output values from determination model 61 for the motor bearing, the determination model 62 for the timing belt, the determination model 63 for the connecting rod, and the determination model 64 for the speed reduction gear of the slide drive system 12a, as the abnormal component. Alternatively, the server 4 determines the component corresponding to the largest value among the output values from determination model 71 for the motor bearing, the determination model 72 for the timing belt, the determination model 73 for the ball screw of the die cushion drive system 32a, as the abnormal component.

In step S404, the server 4 calculates the remaining life of the abnormal component. For example, the server 4 may use a method well known in quality engineering, such as the Mahalanobis-Taguchi method (MT method), to calculate the remaining life of the abnormal component. However, the server 4 may calculate the remaining life using another method.

In step S405, the server 4 updates the predictive maintenance data. The predictive maintenance data is saved in the storage device 58. The predictive maintenance data includes data indicating the remaining life of each of the drive systems of the industrial machines 2A-2C registered in the server 4. The predictive maintenance data includes data indicating the remaining life of a component determined as an abnormal component among the plurality of components of the drive systems.

In step S406, the server 4 determines whether there is a display request for displaying a maintenance management screen. The server 4 determines that there is a display request for displaying the maintenance management screen when a request signal for the maintenance management screen is received from the client computer 6. When there is a display request for displaying the maintenance management screen, the server 4 transmits the management screen data. The management screen data is data for displaying the maintenance management screen on a display 7 of the client computer 6.

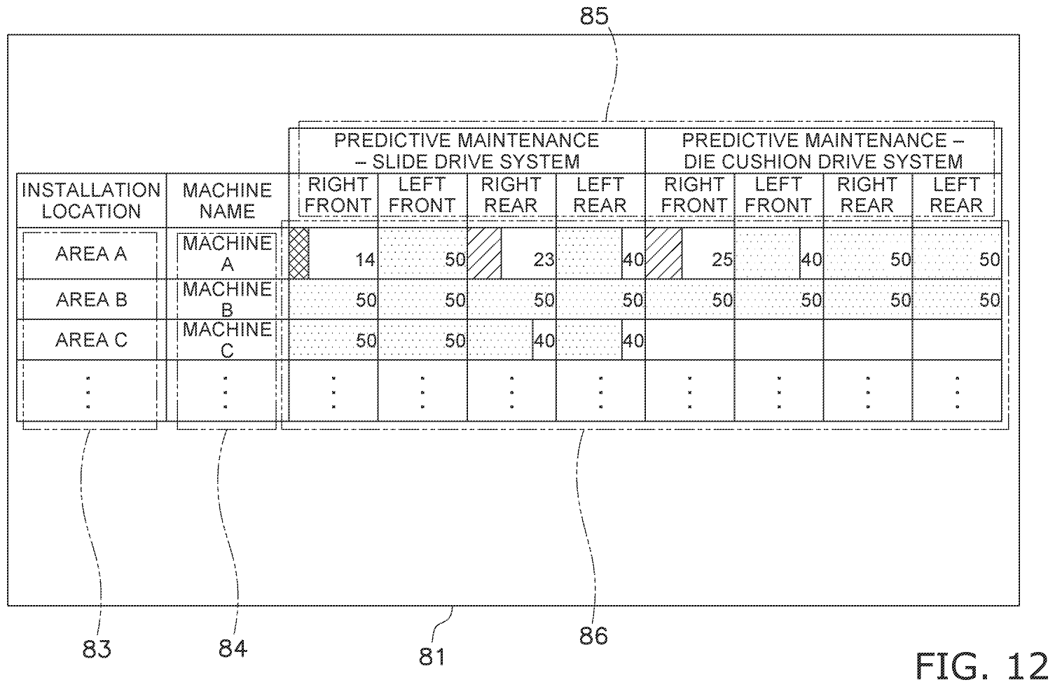

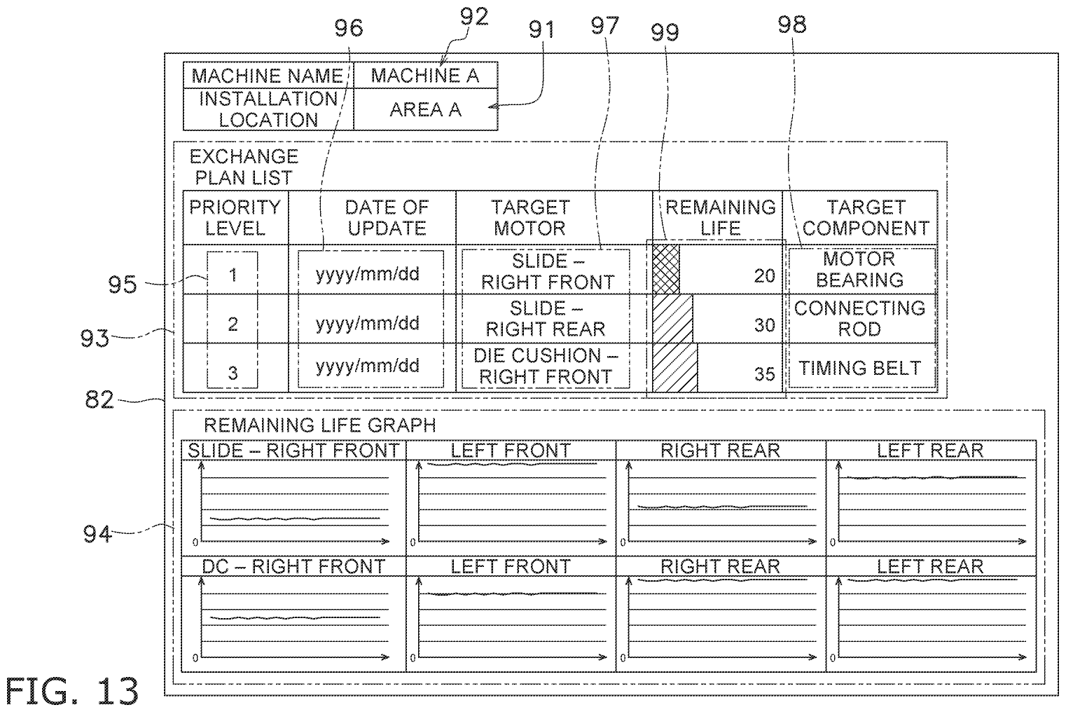

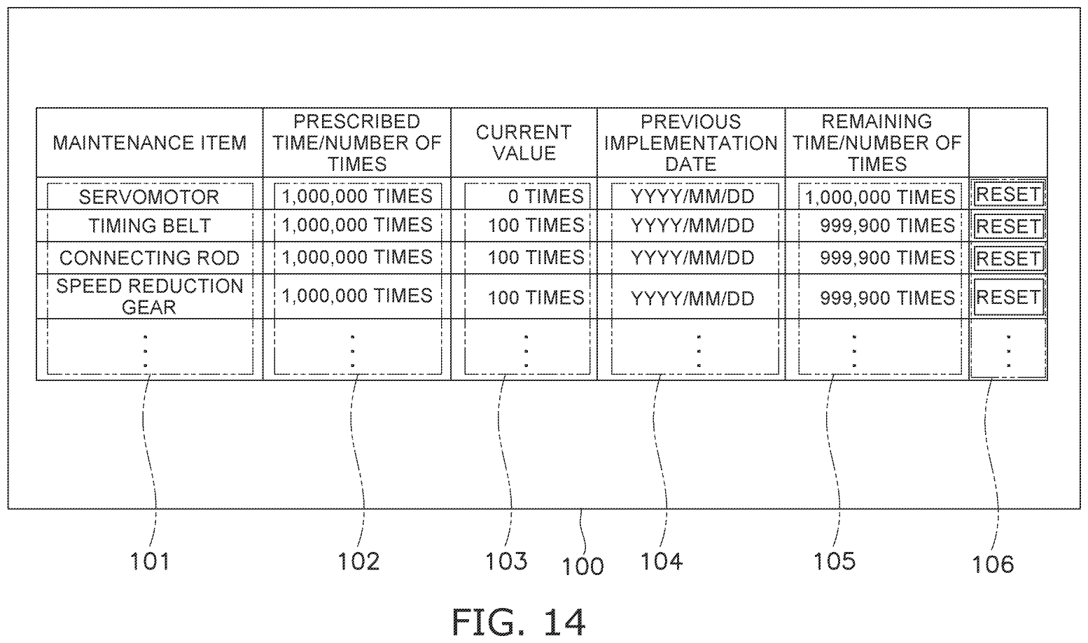

FIG. 12 to FIG. 14 illustrate examples of the maintenance management screen. The maintenance management screen includes a machine list screen 81 illustrated in FIG. 12, an individual machine screen 82 illustrated in FIG. 13, and a maintenance component management screen 100 illustrated in FIG. 14. The user of the client computer 6 is able to selectively display the machine list screen 81 and the individual machine screen 82 on the display 7. When the machine list screen 81 is selected, the server 4 generates data indicating the machine list screen 81 based on the predictive maintenance data, and transmits the data indicating the machine list screen 81 to the client computer 6. When the individual machine screen 82 is selected, the server 4 generates data indicating the machine screen based on the predictive maintenance data, and transmits the data indicating the individual machine screen 82 to the client computer 6.

FIG. 12 illustrates an example of the machine list screen 81. The machine list screen 81 displays the predictive maintenance data pertaining to the plurality of industrial machines 2A-2C registered in the server 4. As illustrated in FIG. 12, the machine list screen 81 includes area identifiers 83, machine identifiers 84, drive system identifiers 85, and life indicators 86. In the machine list screen 81, the area identifiers 83, the machine identifiers 84, the drive system identifiers 85, and the life indicators 86 are displayed as lists.

The area identifiers 83 are identifiers of each area where the industrial machines 2A-2C are disposed. The machine identifiers 84 are the respective identifiers of the industrial machines 2A-2C. The drive system identifiers 85 are identifiers of the slide drive systems 12a-12d or the die cushion drive systems 32a-32d. The identifiers may also be names or codes.

The life indicators 86 represent the remaining life of the respective slide drive systems 12a-12d or the die cushion drive systems 32a-32d for each of the industrial machines 2A-2C. The life indicators 86 include a numerical value indicating the remaining life. The remaining lives are, for example, represented by the number of days. However, the remaining lives may be represented by another unit such as hours.

The life indicators 86 also include a graphic display indicating the remaining life. In the present embodiment, the graphic display is a bar display. The server 4 changes the lengths of the bars of the life indicators 86 in accordance with the respective remaining life. However, the remaining lives may be represented with another display form.

The server 4 may determine the remaining lives from the feature amounts for the drive systems assessed as operating normally in the same way as step S404, and display the respective remaining lives with the life indicators 86. The server 4 may display the remaining life of the abnormal component determined in step S404 for the drive system including the abnormal component, with the life indicators 86.

The server 4 displays the life indicators 86 of the plurality of drive systems in a color-coded manner in accordance with the remaining life in the machine list screen 81. For example, when a remaining life is equal to or greater than a first threshold, the server 4 displays the life indicator 86 in a normal color. When the remaining life is less than the first threshold, the server 4 displays the life indicator 86 in a first warning color. When the remaining life is less than a second threshold, the server 4 displays the life indicator 86 in a second warning color. The second threshold is smaller than the first threshold. The normal color, the first warning color, and the second warning color are different colors. Therefore, the life indicator 86 of a component having a short remaining life is displayed in a color different from the color of a life indicator 86 of a normal component.

FIG. 13 illustrates an example of the individual machine screen 82. The server 4 transmits, to the client computer 6, data for displaying the individual machine screen 82 on the display 7 when a request signal for the individual machine screen 82 is received from the client computer 6. The individual machine screen 82 displays predictive maintenance data pertaining to one of the industrial machines selected from the plurality of industrial machine 2A-2C registered in the server 4. However, the individual machine screen 82 may also display predictive maintenance data pertaining to a plurality of selected industrial machines.

The following is an explanation of the individual machine screen 82 when the industrial machine 2A is selected. The individual machine screen 82 includes an area identifier 91, an industrial machine identifier 92, an exchange planning list 93, and a remaining life graph 94. The area identifier 91 is an identifier of the area where the industrial machine 2A is disposed. The machine identifier 92 is the identifier of the industrial machine 2A.

The exchange planning list 93 displays the predictive maintenance data pertaining to a component on which maintenance is to be performed among the plurality of components. The components determined as abnormal components by the above-mentioned determination models 60 and 70 are displayed in the exchange planning list 93. Therefore, when the server 4 has determined that there is an abnormality in at least one of the plurality of components, the abnormality is reported to the user by displaying said component in the exchange planning list 93.

In the exchange planning list 93, at least a portion of the plurality of components included in the drive systems of the industrial machine 2A are displayed in order from the shortest remaining life. The exchange planning list 93 includes priority levels 95, update dates 96, drive system identifiers 97, component identifiers 98, and life indicators 99.

The priority levels 95 represent a priority level for the exchange of the component in the drive system. The priority levels 95 increase as the remaining life becomes shorter. Therefore, the identifier 98 and the life indicator 99 of the component having the shortest remaining life are displayed at the top in the exchange planning list 93. The update dates 96 represent the previous exchange dates of the components of the drives system. The drive system identifiers 97 are identifiers of the slide drive systems 12a-12d or the die cushion drive systems 32a-32d.

The component identifiers 98 are the identifiers of the components included in the drive system. For example, the component identifier 98 is the identifier of the servomotor, the speed reduction gear, the timing belt, or the connecting rod of the slide drive systems 12a-12d. Alternatively, the component identifier 98 is the identifier of the servomotor, the timing belt, or the ball screw of the die cushion drive systems 32a-32d. The server 4 displays, in the exchange planning list 93, the component identifier 98 of the component that has been determined as the abnormal component using the above-mentioned determination models 60 and 70. The identifiers may also be names or codes.

The life indicators 99 represent the remaining lives of each of the components of the slide drive systems 12a-12d or the die cushion drive systems 32a-32d. The life indicators 99 include a numerical value and a graphic display indicating the remaining life of each component. An explanation of the life indicators 99 is omitted because the life indicators 99 are the same as the above-mentioned life indicators 86 in the machine list screen 81.

The remaining life graphs 94 are obtained by graphing the remaining lives of the drive system 12a-12d and 32a-32d. In each of the remaining life graphs 94, the horizontal axis is the time when the drive system data was acquired and the vertical axis is the remaining life calculated from the feature amounts.

FIG. 14 illustrates an example of the maintenance component management screen 100. As illustrated in FIG. 14, the maintenance component management screen 100 includes displays of maintenance items 101, prescribed time/number of times 102, current values 103, previous implementation dates 104, and remaining time/number of times 105. In addition, the maintenance component management screen 100 includes a reset operation display 106. The maintenance items 101 represent the components on which maintenance is to be performed. For example, the maintenance items 101 represent the respective servomotor, the speed reduction gear, the timing belt, or the connecting rod of the slide drive systems 12a-12d. The maintenance items 101 may also indicate the maintenance work on each component.

The prescribed time/number of times 102 represent the operating time or the number of operations that serve as yardsticks for each component. The current value 103 represents the operating time or the number of operations up to the present time of each component. The previous implementation dates 104 represent the implementation date of the previous maintenance work on each component. The maintenance work is, for example, the exchange of the component. For example, the component having the shortest machine life indicated in the individual machine screen 82 is exchanged in the maintenance work. The remaining time/number of times 105 represents the remaining operating time or the remaining number of operations up to the prescribed time/number of times 102. The above parameters are transmitted from the respective controllers 5A-5C of the industrial machines 2A-2C via the local computers 3A-3C to the server 4 and saved in the storage device 58 of the server 4 as the predictive maintenance data.

The reset operation display 106 is a display for the user to perform an operation for resetting the current values 103 and the remaining time/number of times 105 of each component and returning the values to the initial values. The user uses a user interface such as a pointing device to operate the reset operation display 106. The user operates the reset operation display 106 for a component on the maintenance component management screen 100 when maintenance work is performed on said component. When the reset operation display 106 is operated, the client computer 6 transmits a signal for indicating the completion of the maintenance work to the server 4. The signal indicating the completion of the maintenance work includes the identifier indicating the component that received the maintenance work and a request for resetting. The server 4 resets the current value 103 and the remaining time/number of times 105 of the component in question, returns the current value 103 and the remaining time/number of times 105 to the initial values, and updates the predictive maintenance data upon receiving the signal for indicating the completion of the maintenance work.

In the predictive maintenance system 1 according to the present embodiment discussed above, the average and the standard deviation obtained by performing Gaussian distribution on the analysis data are used as feature amounts to determine whether the drive system 12a-12d and 32a-32d are operating normally. Consequently, an abnormality in the drive system 12a-12d and 32a-32d can be determined easily and accurately. In addition, the data amount of the feature amounts is less than the analysis data. As a result, screening of the normal analysis data and the abnormal analysis data can be performed before using the analysis data to determine an abnormality. Consequently, the communication load between the server 4 and the local computers 3A-3C or the computation load of the server 4 is reduced.

Although an embodiment of the present invention has been described so far, the present invention is not limited to the above embodiment and various modifications may be made within the scope of the invention. For example, the industrial machine 2A is not limited to a press and may be another machine such as a welder or a cutter. A portion of the above-mentioned processing may be omitted or changed. The order of the above-mentioned processing may also be changed.

The configurations of the local computers 3A-3C may be changed. For example, the local computer 3A may include a plurality of computers. The above-mentioned processing performed by the local computer 3A may be distributed among the plurality of computers and executed. The local computer 3A may also include a plurality of processors. The other local computers 3B and 3C may be changed in the same way as the local computer 3A.

The configuration of the server 4 may be changed. For example, the server 4 may include a plurality of computers. Processing performed with the above-mentioned server 4 may be distributed among the plurality of computers and executed. The server 4 may also include a plurality of processors. At least a portion of the above-mentioned processing may be executed by another processor, such as a graphics processing unit (GPU), without being limited to a CPU. The above-mentioned processes may distributed and executed among the plurality of processors.

The method for determining the abnormality by means of the analysis data is not limited to that of the above embodiment and may be changed. The feature amount may include only one of the average and standard deviation of the Gaussian distribution. The analysis data is not limited to fast Fourier transform and may be acquired with another frequency analysis, such as discrete Fourier transform. The determination model is not limited to a neural network and may be another machine learning model such as a support vector machine. The determination models 61-64 may be integrated. The determination models 71-73 may be integrated.

The components subjected to the determination by means of the determination models are not limited to those of the above embodiment and may be changed. The drive system data is not limited to the angular acceleration of a motor and may be changed. For example, the drive system data may be the acceleration or the velocity of a component other than a motor, such as a timing belt or a connecting rod. Alternatively, the drive system data may be sound emitted from the industrial machines 2A-2C.

The maintenance management screens are not limited to the above embodiment and may be changed. For example, the items included in the machine list screen 81, the individual machine screen 82, and/or the maintenance component management screen 100 may be changed. The display forms of the machine list screen 81, the individual machine screen 82, and/or the maintenance component management screen 100 may be changed. A part of the machine list screen 81, the individual machine screen 82, and the maintenance component management screen 100 may be omitted.

The determination results by the determination model of the component to be subjected to the maintenance may be reported to the user not only by the above-mentioned maintenance management screen but also by another method. For example, the determination results may be reported to the user with another communication means, such as email.

In step S105, the local computer 3A may transmit the feature amounts and the analysis data to the server 4. In this case, the step S203 may be omitted. The determining of the abnormality with the feature amounts may be executed not only by the server 4 but also by the local computers 3A-3C.

Based on the method and system according to the present disclosure, an abnormality of an industrial machine can be determined easily and accurately.

1. A method executed by one or more computers for determining an abnormality in an industrial machine including a drive system, the method comprising:
acquiring drive system data indicating a dynamic state of the drive system;
performing frequency analysis on the drive system data to acquire analysis data indicating a power spectrum of the drive system data;
deriving a Gaussian distribution of the analysis data and acquiring a feature amount indicating the Gaussian distribution; and
determining whether the drive system is operating abnormally based on the feature amount.

2. The method according to claim 1, wherein
the feature amount includes an average of the Gaussian distribution.

3. The method according to claim 1, wherein
the feature amount includes a standard deviation of the Gaussian distribution.

4. The method according to claim 1, wherein
the frequency analysis is a fast Fourier transform.

5. The method according to claim 1, further comprising
calculating a life of a specific component of the drive system based on the analysis data when it is determined that the drive system is operating abnormally based on the feature amount.

6. A system for determining an abnormality in an industrial machine including a drive system, the system comprising:
a local computer configured to
acquire drive system data indicating a dynamic state of the drive system,
perform frequency analysis on the drive system data to acquire analysis data indicating a power spectrum of the drive system data,
derive a Gaussian distribution of the analysis data, and
acquire a feature amount indicating the Gaussian distribution; and
a server configured to
communicate with the local computer,
acquire the feature amount from the local computer, and
determine whether the drive system is operating abnormally based on the feature amount.

7. The system as in claim 6, wherein
the feature amount includes an average of the Gaussian distribution.

8. The system according to claim 6, wherein
the feature amount includes a standard deviation of the Gaussian distribution.

9. The system according to claim 6, wherein
the frequency analysis is a fast Fourier transform.

10. The system according to claim 6, wherein
the server is further configured to
acquire the analysis data from the local computer when the drive system is determined to be operating abnormally based on the feature amount, and
calculate a life of a specific component of the drive system based on the analysis data.

11. The method according to claim 2, wherein
the feature amount includes a standard deviation of the Gaussian distribution.

12. The method according to claim 11, wherein
the frequency analysis is a fast Fourier transform.

13. The method according to claim 12, further comprising
calculating a life of a specific component of the drive system based on the analysis data when it is determined that the drive system is operating abnormally based on the feature amount.

14. The system according to claim 7, wherein
the feature amount includes a standard deviation of the Gaussian distribution.

15. The system according to claim 14, wherein
the frequency analysis is a fast Fourier transform.

16. The system according to claim 15, wherein
the server is further configured to
acquire the analysis data from the local computer when the drive system is determined to be operating abnormally based on the feature amount, and
calculate a life of a specific component of the drive system based on the analysis data.
